(19) United States
(12) Patent Application Publication
(10) Pub. No.: US 2004/0219863 A1
(43) Pub. Date: Nov. 4, 2004

(54) Method and apparatus for distributing treatment agents

(76) Inventor: Geoffrey Valentine Willacy, Tauranga (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/478,527

(22) PCT Filed: May 14, 2002
(86) PCT No.: PCT/NZ02/00094

(30) Foreign Application Priority Data
May 22, 2001 (NZ) 511845

(51) Int. Cl. A01K 51/00

(52) U.S. Cl. 449/2

(57) ABSTRACT

A treatment agent delivery system which includes at least one distribution surface adapted to be located in close proximity to an insect travel route and a spray delivery system including a nozzle, electronic controls and a battery, with the spray delivery system adapted to spray at least one treatment agent onto said distribution surface.

### TECHNICAL FIELD

This invention relates to a method and apparatus for distributing treatment agents to vegetation. Preferably the invention uses bees or other insects to distribute the treatment agents to vegetation through such agents being sprayed onto a surface which the bees or insects pass regularly, such as the exit to a beehive. For use of reference only throughout the specification, will refer to bees being employed to spread treatment agents and the apparatus associated with the present invention being located on or within a beehive. However, those skilled in the art should appreciate that other insects may also be used to distribute treatment agents without departing from the scope of the present invention.

### BACKGROUND ART

In many instances it is desirable to apply a treatment agent or agents to a vegetative crop. Previously, for example, bees have been employed to distribute treatment agents to crops as they visit flowers to collect nectar and pollen. Good examples of systems that exploit this facet of bee behaviour are described in U.S. Pat. No. 5,348,511 and United Kingdom Patent No. 1,470,385.

These types of apparatus employ a container or trough of agent that is situated at the exit to a beehive. Bees leaving the hive come into contact with the container of agent which adheres to their bodies. The agent is then distributed throughout the vegetation to be treated as the bees travel around collecting nectar and pollen.

However, there are some problems with the design and use of such systems.

In the case where the treatment agent is pollen, bees when confronted by a container full of pollen will immediately collect the pollen they require and try to return back into the interior of the hive. This negates the purpose of providing such an apparatus as the bee does not come into contact with the crop to be pollinated. To address this problem existing systems normally separate the exit to the hive from the entrance. Although a bee may exit the hive and come into contact with the container of agent, they cannot immediately retreat back into the hive from the same exit point. By forcing the hive to use a separate entrance the developers of such systems hope to encourage the bee to travel out to the surrounding vegetation.

However, the provision of a separate entrance and exit to a hive can cause substantial confusion to the bee population, as bees need a significant amount of time to recognise that the entrance and exit of the hive are at separate locations. During this “training time” high bee mortality rates can be experienced, and the efficiency of the hive in distributing treatment agents or producing bee products can be severely reduced.

In addition, a further drawback with these systems arises as a consequence of providing a large container or trough of treatment agent, as the apparatus need only be attended infrequently. Thus, as a large trough of agent can be left for long periods within the apparatus, through exposure to air and water the treatment agent can experience a loss in viability or potency over time.

Accordingly, there is a need for an improved method or apparatus for distributing treatment agents that addresses any or all of the above problems. Consequently, a system which could provide a single combined entrance and exit point to a beehive (for example) and which regularly distributed small quantities of treatment agent would be of advantage.

It is an object of the present invention to address the foregoing problems or at least to provide the public with a useful choice.

Further aspects and advantages of the present invention will become apparent from the ensuing description that is given by way of example only.

### DISCLOSURE OF INVENTION

According to one aspect of the present invention there is provided a treatment agent delivery system which includes,

at least one distribution surface adapted to be located in close proximity to an insect travel route, and

a spray delivery system adapted to spray at least one treatment agent onto said distribution surface(s).

According to a further aspect of the present invention there is provided a treatment agent delivery system substantially as described above wherein the system is adapted to evenly deliver treatment agents on to said distribution surface(s).

According to a further aspect of the present invention there is provided a treatment agent delivery system substantially as described above wherein the activation of the spray delivery system is timed to spray treatment agents after a set period of time.

According to yet another aspect of the present invention there is provided a treatment agent delivery system substantially as described above wherein said at least one distribution surface is adapted to form a portion of both an entrance and an exit to an insect colony.

According to another aspect of the present invention there is provided a method of delivering a treatment agent characterised by the steps of:

(a) locating at least one distribution surface in close proximity to an insect travel route, and

(b) spraying at least one treatment agent onto said at least one distribution surface.

According to a further aspect of the present invention there is provided a method of delivering a treatment agent substantially as described above wherein the spraying of treatment agent occurs at regular time intervals onto said distribution surface(s).

According to a further aspect of the present invention there is provided a method of delivering a treatment agent utilising bees as delivery agents characterised by the step of using a propellant to deliver at pre-set intervals via a delivery line a predetermined amount of treatment agent evenly to at least one distribution surface positioned at the exit to a beehive.

According to a further aspect of the present invention there is provided a device for delivering a treatment agent to bees residing in a beehive, wherein the device includes:

(a) a source of treatment agent and a source of propellant connected via a first delivery line, and

(b) a control device, and

(c) at least one valve, and

(d) a second delivery line connected at a first end to the source of treatment agent and connected to a nozzle at a second end thereof, and

(e) a distribution surface positioned at the exit to a hive,

wherein the device is configured so that the control device controls said valve(s) positioned in the first delivery line to time the delivery of propellant to the treatment agent source at pre-set intervals, such that when the propellant enters the source of treatment agent to force the treatment agent out the second delivery line via a nozzle, treatment agent is delivered to the distribution surface(s).

The present invention is adapted to provide a method for and an apparatus or device to used to deliver a treatment agent or agents to vegetation. Preferably the invention may employ well known facets of insect behaviour to employ insects to distribute treatment agents throughout an area of vegetation, where the apparatus or device employed applies the treatment agent to the insects.

The present invention may employ insects of any type to effectively distribute a treatment agent through an area of vegetation. Any insect species which is known to travel within or visit a particular area which a delivery device or system may be located can be employed in conjunction with the present invention.

Reference throughout this specification will be made to the insect used to spread or distribute treatment agents as being bees. However, those skilled in the art should appreciate that any other type of insect which exhibits useful behaviour and will predictably visits or uses a travel route which can be identified may be employed in conjunction with the present invention. For example, in some instances ants or wasps, may be used to distribute treatment agents in other embodiments if required.

In a preferred embodiment a delivery system configured in accordance with the present invention may be located at, on, or within a travel route for the insects selected. A travel route may be defined as any region, area or location which the insects selected are known to visit.

In a further preferred embodiment the insect travel route or location involved may be the exit of a beehive. By locating a delivery system at the beehive's exit an operator of the present invention can ensure that a large number of bees will come into contact with the delivery system and have treatment agent applied to their bodies.

Reference throughout this specification will be made to a delivery system being located at the exit of the beehive. However those skilled in the art should appreciate that other locations for such systems may also be employed and use of the invention need not necessarily be limited to beehives only. For example, such a treatment agent delivery system may be located at the exit of any form of insect colony that insects inhabit.

Preferably a treatment agent which may be delivered or distributed by the present invention may be any compound which can naturally, or can be adapted to, adhere to the surface of a bee, and which requires distribution through an area of vegetation. For example, treatment agents which may be distributed in accordance with the present invention may include pollen for fertilising plants, insecticides (which exhibit no activity in relation to the carrier insect), fungal spores, bacterium or any other organism which may attack a pest insect or organism present on or within the vegetation to be treated. Reference throughout this specification will also be made to the present invention primarily being used to spread or distribute pollen. However, those skilled in the art should appreciate that other forms of treatment agents or combinations of treatment agents may also be delivered in accordance with the present invention.

Preferably treatment agents employed may exhibit surface or electrical charge characteristics which allow the agents to be attracted and adhere to the body of an insect. In further preferred embodiments a carrier material may also be added to the treatment agents to ensure that the agents exhibit sufficient adhesion to the body of a bee. For example, in some instances the treatment agents may be mixed with a sticky adhesive or alternatively may be given a slight electrostatic charge to allow the agents to adhere to and remain in contact with the body of a bee until they are rubbed off (preferably on the flowers of the vegetation to be treated).

Preferably the delivery system or device provided by the present invention may include at least one distribution surface which is located next to or may form a portion of an exit to a beehive. Such a distribution surface or surfaces may preferably form part of both a combined entrance and exit to a beehive, thereby eliminating the need to retrain the bees of the hive in the use of a separate entrance and exit when the delivery system is installed. This placement of such a distribution surface or surfaces ensures that bees entering or exiting the hive will have to come in contact with a distribution surface.

In a preferred embodiment the present invention includes a spray delivery system which is adapted to spray at least one treatment agent on to said at least one distribution surface. The placement of the distribution surface or surfaces employed will then ensure that the bees come into contact with the spray treatment agent as they exit or enter their hive.

In a further preferred embodiment the present invention may include a single distribution surface only which is configured or shaped as a ramp which bees must walk up to exit the hive or walk down to enter the hive. In a further preferred embodiment the ramp employed may have its slope at a substantially 45° angle]. The applicants have found that this angle of incline promotes an even distribution of spray over the delivery ramp. However, it should be appreciated that other angles of ramp are envisage and may be utilised depending on the nature of the treatment agent to be delivered.

Reference throughout this specification will also be made to the present invention employing an incline ramp as the single distribution surface incorporated into the delivery system or device. However, those skilled in the art should appreciate that other configurations of distribution surface or surfaces may also be employed and reference to the above only throughout this specification should in no way be seen as limiting.

Preferably the spray delivery system employed may create an airborne distribution of treatment agent particles when activated. The spray system need not necessarily atomise treatment agent nor should it be considered essential for the spray system to spray treatment agents in liquid forms only. The spray delivery system employed may create an airborne distribution of treatment agent particles which in turn can be directed to and impact with the distribution surface ramp.

The spray delivery system may preferably include a nozzle to create an air borne such distribution of treatment agent The nozzle can also be used to aim the treatment agent at specific areas of the ramp if required.

The use of a spray delivery system and a distribution surface ramp eliminates the need for the delivery system or device to employ a container filled with treatment agent. This eliminates the temptation for bees to “rob” the treatment agent container and return immediately to the interior of the hive. As a relatively low concentration of treatment agent is applied to the ramp it is not immediately obvious to the bees that they are coming into contact with pollen that they would normally gather from flowers and bring back to the hive.

Furthermore, small volumes or amounts of treatment agents may be sprayed regularly over a long period of time. This eliminates the exposure of large amounts of treatment agent to air and water over long periods of time, thereby increasing the viability or potency of the treatment agents as only small volumes of agent are exposed to the elements at any one time.

In a preferred embodiment the distribution surface ramp may employ a retention system for an agent sprayed onto same. Such a retention may ensure that when treatment agents are sprayed evenly onto the ramp by the spray delivery system the spray treatment agents stay in the location on the ramp at which they were sprayed.

In further preferred embodiments such a retention system may be created by placing an electrostatic charge on the surface of the ramp. This charge will exhibit an attractive force to the sprayed particles of treatment agent, thereby holding them in place on the ramp and preventing pools of treatment agent from forming at the base of the ramp.

In a preferred embodiment the delivery system may include a control device which times and/or controls the activation of the spray delivery system. Such a control device may be configured to be capable of ensuring that the spray delivery system repetitively applies small amounts of treatment agent to the distribution surface ramp at set periods of time. The control device may also be configured to be capable of preferably controlling the volume or amount of treatment agent sprayed in addition to the times at which such volumes of agent are sprayed. This feature allows a user of the invention control over how much treatment agent is sprayed over long periods of time. Preferably the control device may be programmed:

a) to ensure that the quantities of treatment agent sprayed and the times at which these quantities are sprayed prevent build up of treatment agents on the distribution ramp; and

b) to minimise the risk degradation of the treatment agent occurring due to prolonged exposure to air and/or water.

In a further preferred embodiment a control device employed by the present invention may be formed from a micro processor, micro controller, programmable logic array or any other programmable logic device which can be used to control the operation of a spray delivery system

Reference throughout this specification will also be made to the control device being formed from a micro processor, but those skilled in the art should appreciate that other forms or implementations of control device may also be employed.

In a preferred embodiment the spray delivery system may employ a propellant to force treatment agent on to the distribution surface out through the systems nozzle. A propellant may be introduced into a reservoir of treatment agent to force the treatment agent out through a conduit connected to the nozzle and onto the distribution surface ramp. A valving mechanism may also be employed between the source of propellant and the reservoir or source of treatment agent where this valving mechanism is actuated by the control device micro processor to control when treatment agent is sprayed, and how much treatment agent is sprayed in one application.

For example, in one preferred embodiment a source of purified, compressed air may be used as propellant which is connected by a first delivery line to a reservoir of pollen forming the treatment agent to be delivered. A valve may be located within this first delivery line which can be used by the microprocessor to introduce propellant into the pollen reservoir. The pollen reservoir may also be connected to a first end of a second delivery line which may have its second end connected to a nozzle of the spray delivery system. By introducing compressed air into the reservoir of pollen this will force the pollen out through the nozzle and onto the distribution surface ramp.

The propellant may be any suitable compressed gas which has properties which make it suitable for use with the treatment agent.

In general the propellant may be purified compressed air.

The present invention provides many potential advantages over prior art delivery systems.

By eliminating the need for a large container of treatment agent this in turn eliminates the insect's opportunity to rob the source of treatment agent and return immediately to a beehive or other similar insect colony. By spraying treatment agents, insects are not necessarily aware that they are walking over or through material which they would normally gather from vegetation and will therefore still travel out into the nearby or surrounding vegetation and distribute the treatment agent.

Furthermore, the present invention may also be adapted to provide or form part of a combined entrance and exit to an insect colony (preferably a beehive). Therefore installation of the present invention does not necessarily require that the insects of the colony learn the location of both an exit and entrance point, thereby eliminating the problems associated with this activity.

By regularly spraying small amounts of treatment agent, the potential for treatment agent degradation over long periods of time is reduced. As only small amounts of agent are delivered at one time the bulk of the treatment agents to be delivered are protected until required.

### BRIEF DESCRIPTION OF DRAWINGS

Further aspects of the present invention will become apparent from the following description which is given by way of example only and with reference to the accompanying drawings in which:

FIG. 1 shows a side cross section view of a treatment apparatus when attached to a beehive preferred embodiments, and

FIG. 2 shows a perspective view of the apparatus shown with respect to FIG. 1, and

FIG. 3 shows a block schematic diagram of components used to implement a spray delivery system in accordance with a preferred embodiment of the present invention.

### BEST NODES FOR CARRYING OUT THE INVENTION

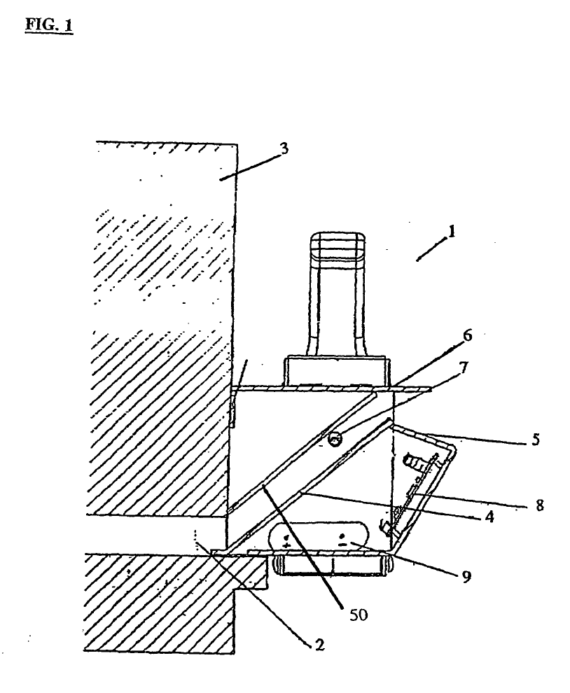

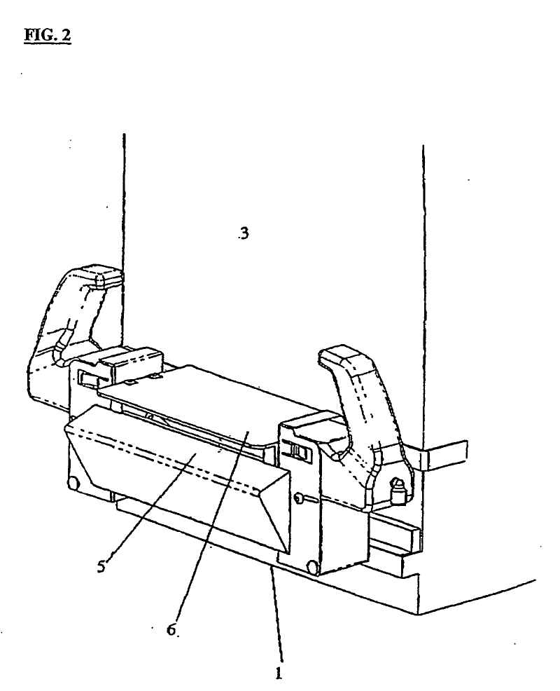

FIGS. 1 and 2 show side cross section and perspective views of a treatment agent delivery system or device 1 formed in accordance with a preferred embodiment of the present invention. In the embodiment shown the system 1 is connected to the combined entrance and exit 2 of the beehive 3. In this instance the insect travel route which the inventions is placed in close proximity to is formed by the hive entrance and exit 2.

The system 1 employs a single distribution surface in the form of a distribution ramp 4. Bees wishing to exit the hive 3 must walk up the ramp and bees entering the hive must walk down the ramp. The upper portions of the ramp 4 are associated with the landing pad 5 for bees approaching the hive and also a roofing element 6 which is formed to prevent rain coming into contact with the surface of the ramp 4. The upper surface 50 of the ramp 4 can also form an additional distribution surface for any bees that decide to walk along this surface to enter/exit the hive 3.

The treatment agent distribution system also includes a spray delivery system (not fully shown) which is adapted to spray treatment agents out of a nozzle 7 onto the surface of the ramp 4. Relatively low concentrations of treatment agent may be sprayed out the nozzle onto the ramp so that bees travelling on the ramp have not immediately realised they are walking through a treatment agent. The spray delivery system may be activated on a time basis through controlling electronic components 8 which incorporate a microprocessor as a control device (not fully shown). These controlling electronics may be powered by a battery pack 9 located within a sealed compartment of the delivery system.

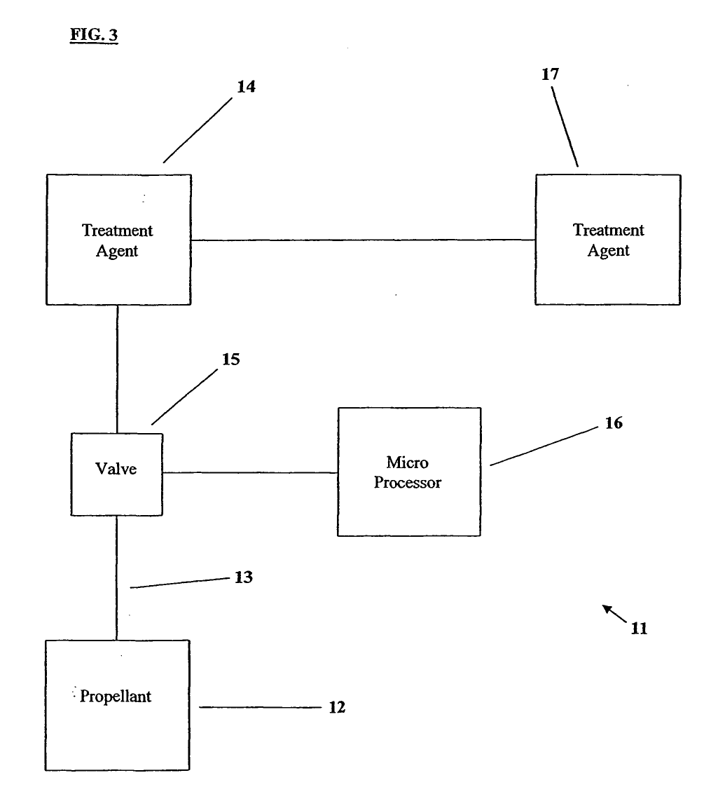

FIG. 3 shows a block schematic diagram of elements employed to form a spray delivery system in accordance with the preferred embodiment of the present invention.

The spray delivery system 11 includes source of propellant 12, formed by a tank of pressurised purified air linked by first delivery line 13 to a source of treatment agent, in the embodiment shown being canister of pollen. Also situated in the interior of the first delivery line is a valve 15, the operation of which is controlled by a control device 16 (in this embodiment being formed by a programmed microprocessor). The control device may open and close the valve 15 at set periods of time during the day to periodically activate the operation of the spray delivery system 11. Furthermore the control device 16 may also control the amount of treatment agent sprayed by controlling the time which the valve 15 stays open.

The source of treatment agent 14 is also connected by a second delivery line to an outlet nozzle 17, where such a nozzle may be directed towards a distribution surface of a treatment agent delivery system. By opening the valve 15 the pressurised propellant 12 will escape to the atmosphere via the nozzle 17, taking a portion of the treatment agents stored at the source 14 with it as it exits.

Aspects of the present invention have been described by way of example only and it should be appreciated that modifications and additions may be made thereto without departing from the scope of the appended claims.

What is claimed is:

1. A treatment agent delivery system comprising:
at least one distribution surface adapted to be located in close proximity to an insect travel route; and
a spray delivery system adapted to spray at least one treatment agent onto the at least one distribution surface, wherein the at least one distribution surface is adapted to form a portion of an entrance or an exit to an insect colony.

2. A treatment agent delivery system as claimed in claim 1, wherein the system is adapted to evenly deliver treatment agents on to said distribution surface.

3. A treatment agent delivery system as claimed in claim 1, wherein the activation of the spray delivery system is timed to spray treatment agents after a set period of time.

4. A treatment agent delivery system as claimed in claim 1, wherein said distribution surface is adapted to form a portion of both an entrance and an exit to a beehive.

5. A treatment agent delivery system as claimed in claim 4, wherein said distribution system is placed in a position to ensure that insects come into contact with the spray treatment agent as they enter or exit their colony.

6. A treatment agent delivery system as claimed in claim 5, wherein the distribution surface is shaped or configured as a ramp which insects much walk up to exit the colony or walk down to enter the colony.

7. A treatment agent delivery system as claimed in claim 6, wherein the ramp has a slope at a substantially 45° angle.

8. A treatment agent delivery system as claimed in claim 1, wherein the spray delivery system creates an airborne distribution of treatment agent when activated.

9. A treatment agent delivery system as claimed in claim 8, wherein a nozzle is used to create an airborne distribution of treatment agent.

10. A treatment agent delivery system as claimed in claim 9, wherein the nozzle can be used to direct the treatment agent to specific areas of said distribution surface.

11. A treatment agent delivery system as claimed in claim 1, wherein said distribution surface employs a retention system for retaining a treatment agent spray on the distribution surface.

12. A treatment agent delivery system as claimed in claim 11, wherein the retention system is operated by placing an electrostatic charge on the surface.

13. A treatment agent delivery system as claimed in claim 1, wherein the distribution surfaces include a roofing element to prevent rain coming into contact with the distribution surface.

14. A treatment agent delivery system as claimed in claim 1, wherein the system also includes a control device which times and/or controls activation of spray delivery system.

15. A treatment agent delivery system as claimed in claim 14, wherein the control device is configured to be capable of ensuring the spray delivery system repetitively applies small amounts of treatment agent to said distribution surfaces at set periods of time.

16. A treatment agent delivery system as claimed in claim 15, wherein the control device is also configured to be capable of controlling the volume or amount of treatment agent sprayed.

17. A treatment agent delivery system as claimed in claim 14, wherein the control device is programmed to:
ensure that the quantities of treatment agent sprayed and times at which these quantities are sprayed prevent the build up of treatment agents on the distribution surface; and
minimise the risk of degradation of the treatment agent occurring due to prolonged exposure to air or water.

18. A treatment agent delivery system as claimed in claim 1, wherein the spray delivery system includes a propellant to force the treatment agent onto said distribution surface.

19. A treatment agent delivery system as claimed in claim 18, wherein the propellant is purified compressed air.

20. A method of delivering a treatment agent characterised by the steps of:
(i) locating at least one distribution surface in close proximity to an insect travel route; and
(ii) spraying at least one treatment agent onto said distribution surface, wherein said distribution surface is adapted to form a portion of both an entrance and an exit to an insect colony.

21. A method of delivering a treatment agent as claimed in claim 20 wherein the spraying of treatment agent occurs at regular time intervals onto said distribution surface.

22. A method of delivering a treatment agent utilising bees as delivery agents characterised by the step of using a propellant to deliver at pre-set intervals via a delivery line a predetermined amount of treatment agent evenly to at least one distribution surface positioned at the exit to a beehive.

23. A device for delivering a treatment agent to bees residing in a beehive, wherein the device includes:
a source of treatment agent and a source of propellant connected via a first delivery line;
a control device;
at least one valve;
a second delivery line connected at a first end to the source of treatment agent and connected to a nozzle at a second end thereof; and
a distribution surface positioned at the exit to a hive, wherein the device is configured so that the control device controls said valve positioned in the first delivery line to time the delivery of propellant to the treatment agent source at pre-set intervals, such that when the propellant enters the source of treatment agent to force the treatment agent out the second delivery line via a nozzle, treatment agent is delivered to the distribution surface.
